(19) United States
(12) Patent Application Publication
(10) Pub. No.: US 2018/0205755 A1
(43) Pub. Date: Jul. 19, 2018

(54) SYSTEMS AND METHODS FOR ADAPTIVE VULNERABILITY DETECTION AND MANAGEMENT

(71) Applicant: University of North Texas, Denton, TX (US)

(72) Inventors: Krishna Kavi, Denton, TX (US); Patrick Kamongi, Denton, TX (US)

(21) Appl. No.: 15/875,724

(22) Filed: Jan. 19, 2018

Related U.S. Application Data
(60) Provisional application No. 62/448,093, filed on Jan. 19, 2017.

(51) Int. Cl. H04L 29/06; G06F 17/30

(52) U.S. Cl. CPC H04L 63/1433; G06F 17/30864

(57) ABSTRACT

Systems and methods providing adaptive vulnerability detection and management are described. Certain embodiments include monitoring system parameters of a cloud-based system, invoking a security ontology knowledge base configured to relate the monitored system parameters to unknown and known vulnerabilities, identifying, based on the monitored system parameters and the invoked security ontology knowledge base, one or more vulnerabilities of the system, and further, implementing a risk management technique for each of the identified one or more vulnerabilities of the system.

### CROSS-REFERENCE TO RELATED APPLICATION

This application claims the benefit of U.S. Provisional Patent Application No. 62/448,093 entitled, “SYSTEMS AND METHODS FOR ADAPTIVE VULNERABILITY DETECTION AND MANAGEMENT,” filed on Jan. 19, 2017, which is expressly incorporated by reference herein in its entirety.

### GOVERNMENT INTEREST

This invention was made with government support under Grant #1361806, awarded by The National Science Foundation. The government has certain rights in the invention.

### TECHNICAL FIELD

The present disclosure relates generally to detection and management of vulnerabilities and, more particularly, to adaptive and automated detection and management of vulnerabilities for cloud systems using ontology knowledge bases.

### BACKGROUND

Cloud computing provides for the delivery of on-demand computing resources. Cloud computing generally includes a variety of components, e.g., from small independent applications to large data centers over the Internet. Cloud computing generally revolves around a custom and/or open source cloud operating system (OS) that controls and provisions allocated resources throughout a data center. Such cloud computing services are deployed mainly in models such as Infrastructure as a Service (IaaS), Platform as a Service (PaaS), and Software as a Service (SaaS). For example, the OpenStack cloud operating system enables developers to design any cloud computing deployment model (e.g., public, private, or hybrid cloud) to support any of the cloud computing services. Cloud computing services are susceptible to potential security threats that may affect confidentiality, integrity, availability, consistency, control, and auditing.

A cloud OS operates much like a typical OS. For instance, it can manage applications and hardware—albeit at a much larger scale. The utilization of cloud OS solutions allow for more efficient management of data center resources including networking, storage and computing, and possible add-on customization tailored to the service and computing resource needs of an organization. Cloud OSs are generally designed around a wide range of technologies, which may exhibit one or more weaknesses and/or vulnerabilities that could potentially be exploited. Inherent flaws in cloud OSs could lead to exposure to threats, leaving cloud assets that utilize these shared technologies vulnerable.

Some methods to discover potential threats towards a cloud's assets include performing a security assessment by identifying known vulnerabilities and their exploits. This task becomes complex due to the wide variety of shared technologies that are part of the cloud's design and deployment. Cloud computing threats may be influenced by different agents, a result of inherent vulnerabilities found in shared technologies used, and/or due to the composition of services of shared technologies.

Certain communities publish known vulnerabilities along with their exploits and available fixes. However, these communities publish reported vulnerabilities/exploits/fixes on an individual technology basis, and therefore do not help identify issues with complex systems that utilize shared technologies. Further, solutions such as these are limited to detecting known/published vulnerabilities, leaving systems exposed to numerous other threats, e.g., “zero-day” attacks, which may exploit unknown/new vulnerabilities.

### SUMMARY

The present application is directed to systems and methods that provide adaptive vulnerability detection and management by utilizing ontology knowledge bases to identify unknown and known vulnerabilities. Certain embodiments include a method that comprises monitoring a plurality of system parameters of a cloud-based system and invoking a security ontology knowledge base. The security ontology knowledge base may be configured to relate the monitored plurality of system parameters to one or more unknown vulnerabilities and one or more known vulnerabilities. Further, the method includes identifying, based on the monitored plurality of system parameters and the invoked security ontology knowledge base, one or more vulnerabilities of the cloud-based system, and implementing a risk management technique for each of the identified one or more vulnerabilities of the cloud-based system.

In another embodiment, a system comprises a memory and a processor coupled to the memory. The processor is configured to execute the steps of monitoring a plurality of system parameters of a cloud-based system, invoking a security ontology knowledge base, wherein the security ontology knowledge base is configured to relate the monitored plurality of system parameters to one or more unknown vulnerabilities and/or one or more known vulnerabilities, identifying, based on the monitored plurality of system parameters and the invoked security ontology knowledge base, one or more vulnerabilities of the cloud-based system, and implementing a risk management technique for each of the identified one or more vulnerabilities of the cloud-based system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a functional block diagram of a system for vulnerability detection and management in accordance with an embodiment of the present application;

FIG. 2 illustrates a method for performing vulnerability detection and management in accordance with an embodiment of the present application;

FIG. 3 illustrates an exemplary high level ontology design representing various concepts in accordance with an embodiment of the present application;

FIG. 4 illustrates an exemplary high level ontology design with a focus on Infrastructure as a Service (IaaS) model in accordance with an embodiment of the present application;

FIG. 5 illustrates an exemplary ontology knowledge base instantiated using the ontology model shown in FIG. 3 in accordance with an embodiment of the present application;

FIG. 6 illustrates an exemplary ontology knowledge base instantiated using the ontology model shown in FIG. 4 in accordance with an embodiment of the present application; and

FIG. 7 illustrates a computed index knowledge graph leveraging both the generated ontology knowledge bases partially shown by FIGS. 5-6 in accordance with an embodiment of the present application.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are exemplary by way of illustration only, and not by way of limitation. Various substitutions, modifications, additions, and/or rearrangements within the spirit and/or scope of the underlying inventive concept will become apparent to those skilled in the art from this disclosure.

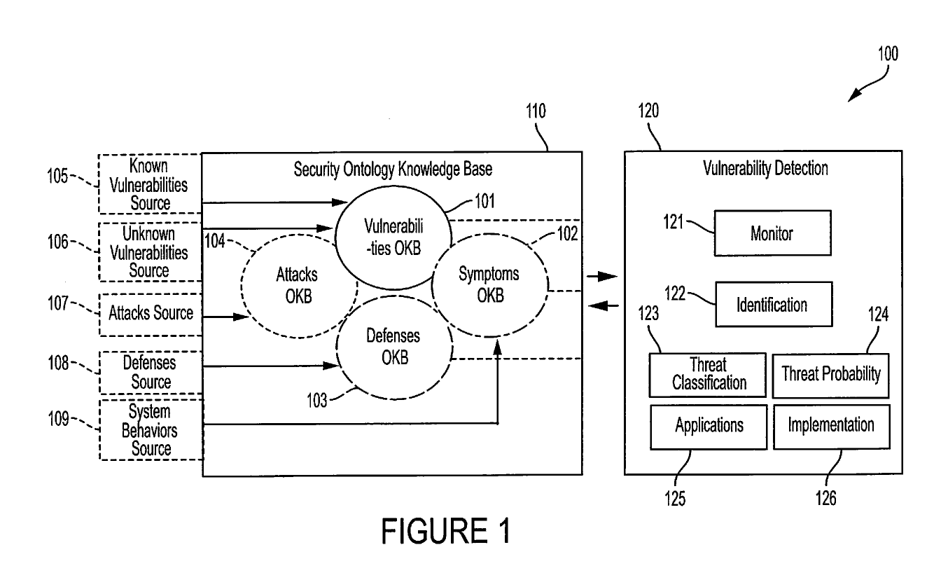

FIG. 1 illustrates a block diagram of a vulnerability detection and management system, in accordance with an embodiment of the present application. System 100 comprises security ontology knowledge base (OKB) module 110 and vulnerability detection module 120. Security OKB module 110 and vulnerability detection module 120 interface with each other such that known and/or unknown vulnerabilities of a cloud-based system may be detected and/or managed, as will be discussed further herein.

Security OKB module 110 may be used as a source of security information and used to generate various security analytics, encompassing areas of vulnerability assessments, e.g., offensive and defensive. Security OKB module 110 may comprise various ontology knowledge bases. For instance, security OKB module 110 may comprise information about various known Information Technology (IT) product vulnerabilities, attacks, and defenses modeled and represented using ontology design and supporting semantic relationships. Security OKB module 110 may also be updated, e.g., automatically and/or on-demand, with relevant vulnerabilities, attacks, and defenses detail for each received cloud configuration entity to be assessed. In response to a query, e.g., active monitoring, and/or user generated query of system parameters, and/or upon detection of a vulnerability (and/or class of vulnerabilities), security OKB module 110 may return a detected vulnerability identifier, description, and severity ranking. If there is an attack associated with the detected vulnerability, security OKB module 110 returns the found exploit identifier and description. If there is a defense associated with the detected vulnerability and/or attack, security OKB module 110 returns the found mitigation identifier and a risk management technique in light of the detected vulnerabilities, attacks, and defenses.

As illustrated by FIG. 1, Security OKB module 110 comprises vulnerabilities OKB 101, symptoms OKB 102, defenses OKB 103, and attacks OKB 104. Each OKB is populated from a respective source as shown in FIG. 1. However, it is appreciated that each OKB is not limited to being populated from its respective source as shown in FIG. 1. In fact, each OKB may be populated from a source that, for example, may populate other OKBs, and/or additional sources not discussed herein. As shown in FIG. 1, possible sources that each OKB may be populated from include known vulnerabilities source 105, unknown vulnerabilities source 106, attacks source 107, defenses source 108, and system behaviors source 109.

In certain embodiments, vulnerabilities OKB 101 may be populated from known vulnerabilities source 105 and unknown vulnerabilities source 106. It is noted that “known vulnerabilities” may include vulnerabilities and/or class(es) of vulnerabilities that are generally known to the public, e.g., vulnerabilities that are documented in public databases, such as the National Vulnerability Database. Vulnerabilities OKB 101 may be populated from any number of these sources that contribute to known vulnerabilities source 105. On the other hand, it is appreciated that “unknown vulnerabilities” may include vulnerabilities that are generally lesser known as compared to known vulnerabilities. Unknown vulnerabilities 106 may include vulnerabilities that are not detectable by normal methods, as known vulnerabilities may normally be. For instance, a vulnerability that is not in a public database may go unnoticed by current systems that only populate vulnerabilities from known vulnerabilities databases like national vulnerability repositories. Unknown vulnerabilities may include vulnerabilities that are limited to being discussed in certain forums, or part of unofficial discussions such as Google Project Zero, where new and/or previously unknown and/or undocumented vulnerabilities are researched and exposed. Unknown vulnerabilities may also include vulnerabilities that are exploited by zero-day attacks, which many systems are vulnerable to. As will be discussed further herein, unknown vulnerabilities source 106 may be accessed by vulnerabilities OKB 101 to adapt to the developing landscape of unknown vulnerabilities.

In certain embodiments, vulnerabilities OKB 101 may also operate such that it may update and/or change the sources it usually is updated from, such as updating known vulnerabilities source 105 and unknown vulnerabilities source 106 with new vulnerability information vulnerabilities OKB 101 obtains from other sources. For example, vulnerabilities OKB 101 may be modified and/or updated by symptoms OKB 102, e.g., if a new vulnerability is discovered after an analysis of currently available known vulnerabilities and known symptoms and system behavior interaction giving way to that vulnerability, this information may be related and assist in the identification of a previously unknown vulnerability. This information may be used to populate vulnerabilities OKB 101 with the previously unknown vulnerability. Further, this identified unknown vulnerability may be relayed back to unknown vulnerabilities source 106, thereby updating unknown vulnerabilities source 106 allowing for future availability to populate OKBs of other systems. For instance, a vulnerability forum may be updated by system 100 with this newly discovered information to further benefit crowd sourced solutions as well as lend to further development of risk management techniques and perceived risk of the vulnerabilities depending on the system. If a forum was updated with this information it may then eventually be entered into a database part of known vulnerabilities source 105, thus recursively updating vulnerabilities OKB 101 with a verified known vulnerability. This adaptive, recursively updating system may automatically improve itself to constantly identify unknown vulnerabilities and update various systems to encourage the dissemination of information to various sources, thus improving the operation of the system, preventing further vulnerabilities. In this sense, each OKB may update any of the other OKBs, as well as update the databases and other sources they are populated therewith.

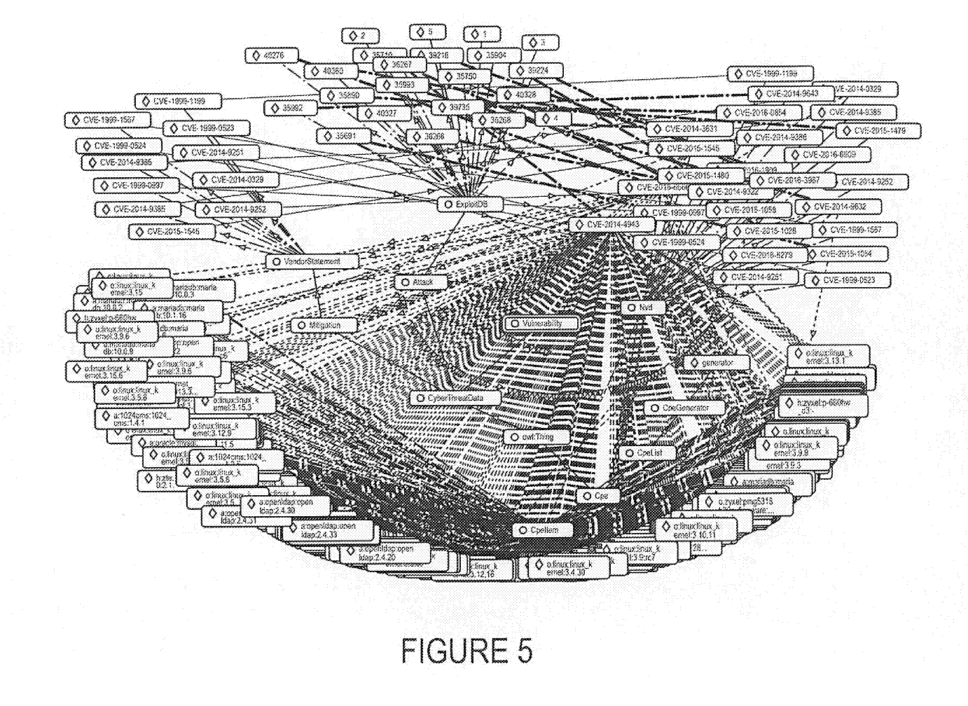

Known vulnerabilities source 105 may include databases such as the National Vulnerability Database (NVD). The NVD collects vulnerability information from various interrelated vulnerability databases, such as Common Vulnerabilities and Exposures (CVE), Common Weakness Enumeration (CWE), Common Platform Enumeration (CPE), Common Vulnerability Scoring System (CVSS), and the like. The NVD compiles vulnerability information into a single database. Each vulnerability in the NVD is identified by a unique identifier referred to as a CVE ID. A typical vulnerability entry in the NVD has a vulnerability identifier, description of the vulnerability, list of software, version of the software in which the vulnerability is found, and a vulnerability severity score collected from appropriate vulnerability databases. The vulnerability databases are generally industry standard databases maintained by NIST and vulnerability information found in these databases is contributed by volunteers across the industry. In certain embodiments, the information from known vulnerabilities source 105, e.g., XML data from the NVD, is extracted to populate vulnerabilities OKB 101. The information may then be mapped to various classes and properties defined by vulnerabilities OKB 101. For example, FIG. 3 illustrates a high level ontology design representing various concepts within the cyber threat data domain (e.g., vulnerability, attack, and mitigation) where each of these concepts and/or classes can be expressed further through various data feeds e.g., National Vulnerability Database (NVD) and Exploit DB vulnerability exploits proof of concept data sources. It is appreciated that some relationships are not shown for sake of simplicity. Further, FIG. 5 illustrates an exemplary ontology knowledge base that has been automatically instantiated using the ontology model shown in FIG. 3.

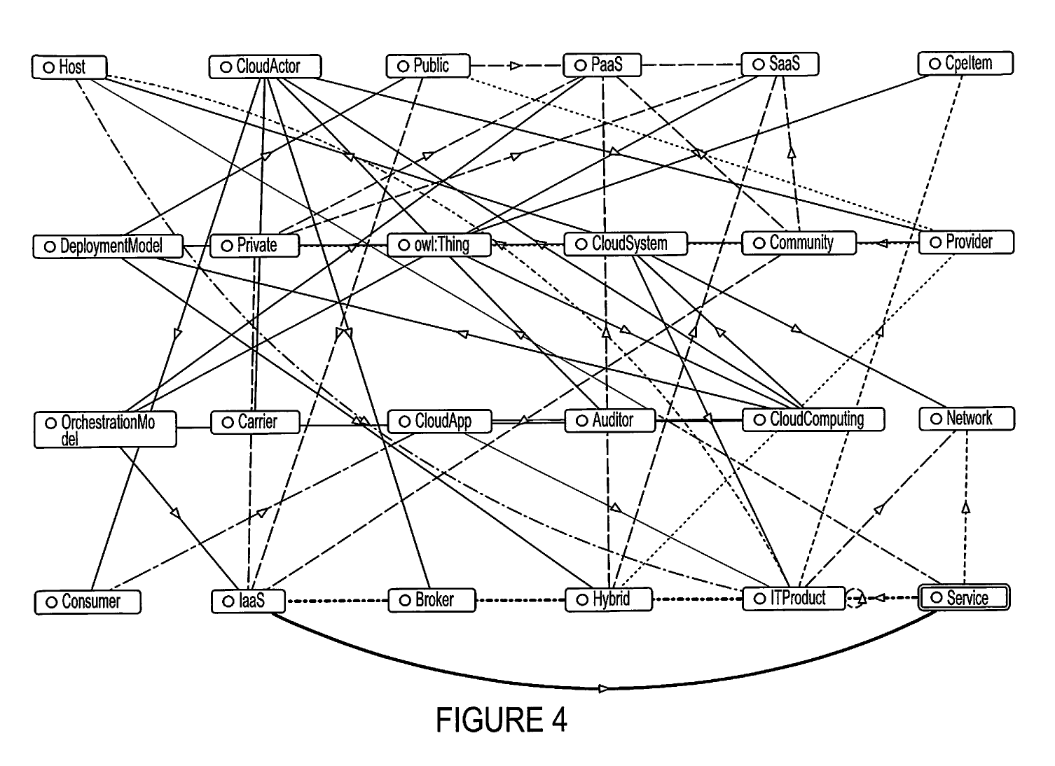

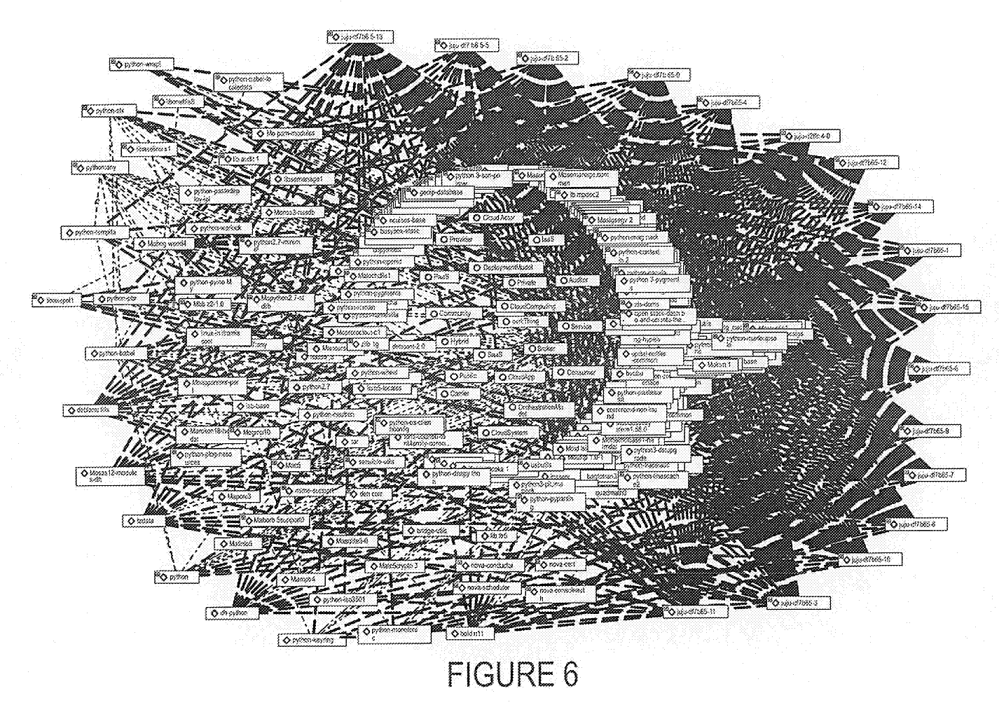

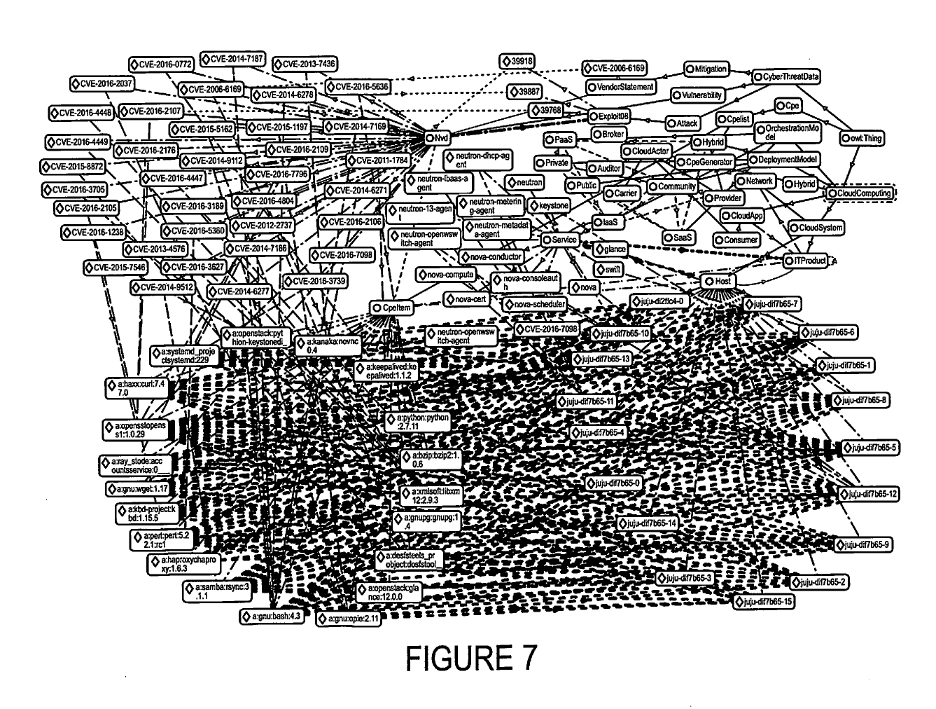

In certain embodiments, vulnerabilities OKB 101 utilizes system classifiers, e.g., dynamic inputs provided to classify separate classes of vulnerabilities within vulnerabilities OKB 101. Classification may include various vendors in the cloud computing domain and various software or hardware components in each service level of cloud computing services. For example, a cloud computing domain could be classified into IaaS, PaaS, and SaaS sub-domains. For example, FIG. 4 illustrates a high level ontology design to represent various concepts within the cloud computing domain with a focus on Infrastructure as a Service (IaaS) model. In each of these domains, software and hardware components used in popular cloud computing vendors are associated, e.g., Xen hypervisor in the IaaS sub-domain, Google App Engine in the PaaS sub-domain, and Salesforce CRM in the SaaS sub-domain. The system classifiers are input into an indexer, and the indexer crawls through vulnerabilities OKB 101 to create an index. For example, this may be demonstrated by FIGS. 6 and 7. FIG. 6 illustrates an exemplary ontology knowledge base that has been automatically instantiated using the ontology model shown in FIG. 4, demonstrating an OpenStack cloud system deployment. FIG. 7 illustrates a computed index knowledge graph leveraging both the fully generated ontology bases partially shown in FIGS. 5-6 to assess the given cloud system security posture in terms of the presence of any known vulnerability along with its coverage of whether it can be exploited or mitigated. The resulting index comprises vulnerabilities grouped according to the provided system classifiers. This index may then be used by a semantic natural language processing (SNLP) module to search vulnerabilities OKB 101 depending on a query, such as from a user attempting to identify a vulnerability and/or automatically by the system. The indexer may then identify all of the vulnerabilities related to software or hardware components listed in the system classifiers and groups them accordingly in the index.

In certain embodiments, these known vulnerabilities may then be grouped into categories provided by the system classifiers, such as “vulnerability classes.” Vulnerability classes may assist in searching for vulnerabilities within a specific domain or sub-domain. For example, at the top level there would be a cloud computing class, with a sub class called PaaS and the PaaS class having Xen hypervisor as its sub class. In the Xen class, there may be a list of vulnerabilities extracted by the indexer from vulnerabilities OKB 101. The SNLP module then enables users to search and reason through vulnerabilities. For example, SNLP may include various sub components which are capable of doing pattern matching, keyword searching, and reasoning over properties and relationships of the classes in vulnerabilities OKB 101. SNLP receives input from a user, determines what the user is asking for, and provides the user a list of vulnerabilities for the requested product and/or class. SNLP is capable of looking up vulnerabilities for the requested product and listing vulnerabilities in a particular class or product across various vendors. SNLP may also reason and list vulnerabilities for a given technology or framework used in the user's application.

Similar to the process discussed above regarding populating vulnerabilities OKB 101 from known vulnerabilities source 105, vulnerabilities OKB 101 may be populated from unknown vulnerabilities source 106. In some embodiments, while known vulnerabilities source 105 may be limited to public and/or national databases of cataloged vulnerabilities, vulnerabilities OKB 101 is configured such that it may be populated from a wider range of sources, including unknown vulnerabilities source 106, thereby ensuring system components are protected from a wide variety of new and/or unknown vulnerabilities as discussed above. As new threats increasingly target previously new and/or unknown vulnerabilities, unknown vulnerabilities source 106 may comprise a wide variety of sources. For instance, vulnerabilities OKB 101 may be populated from unknown vulnerabilities source 106 to properly assess new vulnerabilities, including zero-day vulnerabilities. Zero-day vulnerabilities are hard to detect since, in many cases, there has never been a predecessor or known variant of its form. Therefore, unknown vulnerabilities source 106 includes resources that are more frequently updated with security repositories feeds from initiatives such as Google Project Zero, wherein potential new vulnerabilities are developed and disclosed. Vulnerabilities OKB 101 may also leverage security intelligence that comes from collected analytics of any system, for instance, cloud computing resources management and provisioning intelligence. Further, other sources to populate vulnerabilities OKB 101 with unknown vulnerabilities include security bugs reports of any given software or application through community and/or internal initiatives. For example, where a community of security researchers or practitioners discover and report newly found bugs under a specified vulnerability disclosure policy.

Vulnerabilities OKB 101 may dynamically access unknown vulnerabilities 106 and/or any exemplary cloud environments to identify and manage zero-day type vulnerabilities and the like. As new and/or unknown vulnerabilities are discovered by various groups, vulnerabilities OKB 101 may actively search these networks to continuously update and build upon the identified unknown vulnerabilities. Vulnerabilities OKB 101 may access environments to analyze reports and include them before they become warehoused, and link to databases to look to other sources in order to understand new vulnerabilities and understand how to analyze them. Vulnerabilities OKB 101 may then communicate and modify any of the other OKBs, such as defenses OKB 103 and symptoms OKB 102, to update and manage risk accordingly. For instance, once an unknown vulnerability is identified and populated in unknown vulnerabilities source 106, vulnerabilities OKB 101 may then update known vulnerabilities source 105, disseminating information regarding the vulnerabilities to other groups with access to the resources.

In certain embodiments, security OKB module 110 further comprises symptoms OKB 102. Symptoms OKB 102 is populated from system behaviors source 109. However, it is appreciated that, similar to vulnerabilities OKB 101, symptoms OKB 102 may be populated from any number of sources. In addition to known and unknown vulnerabilities associated with vulnerabilities OKB 101 being linked to monitoring security and threat intelligence reports for the presence of new threats or zero-day attacks, symptoms OKB 102 may collect system data that may indicate the presence of an unknown vulnerability or attack as well. Data collection may be adapted such that newly discovered attacks can be related to system behaviors. A certain number of system behaviors dependent upon the type of system being monitored may indicate the existence or exploitation of a vulnerability and/or class of vulnerability. Particular values of system parameters may indicate and identify zero-day attacks due to previously unknown vulnerabilities. For example, the particular changes in parameters may include abnormal network traffic, excessive writes to disk, memory leaks, etc.

Symptoms OKB 102 may pull from any number of system behaviors to identify a healthy state of a system to compare against monitored system parameters of a target system as will be discussed in further detail. System behaviors source 109 may comprise various system parameters. For example, dependent on the type of system, e.g., cloud-based personal, commercial, government, and the like, there may be a certain set of system parameters that indicate a healthy (e.g., normal) system. Network traffic may have particular throughput that is normal, or higher traffic that may indicate a potential vulnerability, or indicate that a vulnerability has been exploited. Symptoms OKB 102 communicates with any other number of OKBs of security OKB module 110 to relate system parameter behaviors to potential trouble states. System states that are characterized as normal could include examples of normal behavior and abnormal behavior, identify load unbalances, faults, and the like. Statistical techniques such as principal component analysis and machine learning techniques (e.g., regression analysis, support vector machine, and neural nets) may be used to identify the most significant system parameters that accurately point to problem states of a system. For example, the most significant system parameters could be determined by more memory allocation requests, excessive number of threads created, too many writes to disk drives, long response times, etc.

The system parameters that are populated in symptoms OKB 102 may then be used to relate system behaviors to known and unknown vulnerabilities and/or classes of vulnerabilities as populated in vulnerabilities OKB 101. The system data, e.g., network, processor, memory, I/O, disk, etc. can be benchmarked to demonstrate a healthy state system. A healthy system could be one that has no malware and/or cyber-attacks, and would be reflected in the healthy state system parameters. One can then inject vulnerabilities into a healthy system and observe the values of the system parameter. The differences between a healthy system and a vulnerability injected system can then be used as the symptom associated with the known vulnerability. Abnormal behaviors that cannot be related to one or more known vulnerabilities may reveal the discovery or a new or unknown vulnerability. Statistical measures, principal component analysis, and/or machine learning techniques, can then be used to associate the primary system parameter data to indicate vulnerabilities and/or exploits of vulnerabilities. In conjunction with vulnerabilities OKB 101, this potential vulnerability based on system parameters and symptoms OKB 102 may be identified as known or unknown and an appropriate remedy implemented. The presence of a vulnerability based on system parameter differences may then lead to identification of the attack type and vulnerabilities that may be exploited.

In certain embodiments, security OKB module 110 further comprises defenses OKB 103 and attacks OKB 104. Similar to the foregoing discussion with respect to vulnerabilities OKB 101 and symptoms OKB 102, defenses OKB 103 and attacks OKB 104 are populated in a similar manner. For instance, defenses OKB 103 may be populated from numerous sources, including defenses source 108 and attacks OKB 104 may be populated from attacks source 107. Attacks OKB 104 may be populated with proof of concept exploits of known vulnerabilities (an example is shown in FIG. 5). Attacks OKB 104 may also be populated with, for instance, the Microsoft STRIDE threat model as will be discussed later in more detail with respect to threat classification.

In certain embodiments, the areas where any exemplary cloud system is most vulnerable during its design or deployment phase may be identified. Certain threats/attacks may affect some types of systems more than others. For instance, a denial of service attack may have far greater ramifications in a commercial environment as opposed to a private network. The OKBs constituting security OKB module 110 may therefore select appropriate tools and implement the best design to protect a particular cloud's assets. The Microsoft STRIDE threat model may be used to classify and rank discovered threat types for each of the cloud's building blocks which are made of various shared technologies. STRIDE information may populate attacks OKB 104 and be linked to the other OKBs for risk management. STRIDE includes six threat categories: (1) Spoofing Identity, (2) Tampering with Data, (3) Repudiation, (4) Information Disclosure, (5) Denial of Service (DoS), and (6) Elevation of Privilege. In certain embodiments, predictive models and metrics are implemented in an automated process to generate a risk indicator for an exemplary cloud system configuration. Risk assessment involves weighting accumulated measurements into an indicator that reflects the risk level of found vulnerabilities, exploits, and defenses per threat type generated from the STRIDE model.

(1) Spoofing Identity includes illegally accessing and using another user's authentication information, e.g., username and password. (2) Data tampering includes the malicious modification of data, e.g., unauthorized changes made to persistent data, such as that held in a database, and the alteration of data as it flows between two computers over an open network. (3) Repudiation includes threats that are associated with users who deny performing an action without other parties having anyway to prove otherwise, e.g., a user performs an illegal operation in a system that lacks the ability to trace the prohibited operations. Nonrepudiation, on the other hand, refers to the ability of a system to counter repudiation threats, e.g., a user who purchases an item might have to sign for the item upon receipt, in which case a vendor can then use the signed receipt as evidence that the user did receive the package. (4) Information disclosure threats include exposure of information to individuals who are not supposed to have access to it, e.g., the ability of users to read a file that they were not granted access to and/or the ability of an intruder to read data in transit between two computers. (5) DoS attacks include denying service to valid users, e.g., by making a web server temporarily unavailable or unusable. Protecting against certain types of DoS threats improves system availability and reliability. With DoS threats, an unprivileged user gains privileged access to compromise the entire system. (6) Elevation of privilege threats include situations in which an attacker has effectively penetrated all system defenses and become part of the trusted system itself.

Similar to attacks OKB 104, defenses OKB 103 may be populated with various mitigation and remediation techniques corresponding to various other OKBs, including vulnerabilities OKB 101 (such as patch information on known vulnerabilities), symptoms OKB 102, and attacks OKB 104. For instance, the STRIDE threat types populated in attacks OKB 104 may have corresponding mitigation techniques for each threat type. For (1) Spoofing Identity, mitigation techniques may include stricter authentication procedures, e.g., two-step authentication. Mitigation techniques may further include increased protection of sensitive data and prevention of servers from storing sensitive data, e.g., personal information. For (2) Tampering with Data, mitigation techniques may include authorization, hashes, message authentication codes, digital signatures, tamper resistant protocols, etc. For (3) Repudiation, mitigation techniques may include digital signatures, timestamps, audit trails, and the like. For (4) Information Disclosure, mitigation techniques may include authorization, privacy-enhanced protocols, encryption, increased protection of sensitive data, and prevention of servers from storing sensitive data. For (5) Denial of Service, mitigation techniques may include authentication, authorization, filtering, throttling, quality of service, and the like. Lastly, for (6) Elevation of privilege, mitigation techniques may include running with the least privilege level, and along with suitable security best practices. In other embodiments, defenses OKB 103 may be populated from additional sources, including from any number of OKBs. For instance, in the event an unknown vulnerability is identified and defense may or may not be associated with it, the system may update to reflect a particular technique to address the issue. Such techniques may include reducing the attack surface which could be achieved on a case by case basis, where for example one can use metrics to select which services or applications need the highest level of protection from public access or a limited set of active functionalities.

In certain embodiments, security OKB module 110, e.g., comprising vulnerabilities OKB 101, symptoms OKB 102, defenses OKB 103, and attacks OKB 104 as discussed above, may be utilized to facilitate automatic adaptive vulnerability assessment for a cloud-based system (e.g., as shown by FIG. 7). Vulnerabilities OKB 101, symptoms OKB 102, defenses OKB 103, and attacks OKB 104 are linked such that they may be utilized in conjunction and searched recursively to identify vulnerabilities. As described above, each OKB uses SNLP in order to facilitate querying. For example, the association of an exemplary attack contained in attacks OKB 104 may be linked to a particular vulnerability contained in vulnerabilities OKB 101, conveying information regarding what may be potentially exploited during the attack. Being linked and able to be recursively searched provide defense mechanisms, such as those contained in defenses OKB 103, that factor in the source of the vulnerability and attack and how they might be mitigated. The relationship can then be analyzed to determine a vulnerability's lifecycle, and the like. This information regarding vulnerabilities and exploits of an exemplary technology or its association with the cloud's assets may serve as support for performing threat modeling and risk assessment of a cloud's setting.

As illustrated by FIG. 1, according to one embodiment, system 100 further comprises vulnerability detection module 120. Vulnerability detection module 120 includes monitor module 121, identification module 122, threat classification module 123, threat probability module 124, applications module 125, and implementation module 126. Vulnerability detection module 120 operates along with security OKB 110 to monitor system parameters via monitor module 121, identify vulnerabilities with identification module 122, e.g., by relating monitored system parameters from monitor module 121 to security OKB 110 data. Further, identified vulnerabilities may be processed through additional modules, including threat classification module 123, threat probability module 124, applications module 125, and implementation module 126.

In certain embodiments, system parameters may be monitored by monitor module 121. System parameters may include network traffic, processors, memory, I/O use, bandwidth usage, computer usage logs, load monitoring, and faults. Depending on the system, e.g., personal, commercial, government, etc., different system parameters may be monitored that are more applicable to the respective system. Monitor module 121 may utilize various systems and processes to monitor system parameters, e.g., monitor usage logs, activity, inputs by various users, and the like. This data may be analyzed by statistical techniques and machine learning. Monitor module 121 may interact with symptoms OKB 102 to determine relevant parameters to be monitored dependent on the use and type of system at issue. On the other hand, a user may direct the system to monitor any particular set of parameters.

In certain embodiments, identification module 122 utilizes the monitored parameters of monitor module 121 and security OKB 110 in order to identify vulnerabilities of the system. Identification module 122 may invoke security OKB 110 in order to relate the monitored system parameters to vulnerabilities OKB 101, symptoms OKB 102, defenses OKB 103, and/or attacks OKB 104. In certain embodiments, identification module 122 and other modules of system 100 may be configured to be consolidated such that any module may invoke security OKB 110. Identification module 122 may compare the monitored system parameters to the healthy state parameters pertaining to a similar exemplary system populated in symptoms OKB 102. Deviations between the behavior of the monitored system parameters and the healthy state parameters of symptoms OKB 102 may be indicative of a vulnerability. Further, known and unknown vulnerabilities of vulnerabilities OKB 101 may be compared to the system at issue to determine if any vulnerabilities are present and attacks OKB 104 may be invoked to suggest potential exploits that could be directed to the vulnerabilities system. Further, risk management techniques may be suggested by relating the identified vulnerabilities to defenses OKB 103 in order to manage the vulnerabilities of the system.

In certain embodiments, once vulnerabilities have been identified based on the monitored system parameters from monitor module 121 and security OKB module 110, the vulnerabilities may be classified by threat classification module 123, and the level of risk determined by threat probability module 124. The STRIDE threat model (or any other suitable threat model) may be used with embodiments discussed herein to address vectors that can be used to threaten a cloud system and to classify them into relevant threat types. For example, an automated STRIDE threat type classification approach to model each discovered cloud configuration entity and its discovered vulnerabilities may be used. An automated procedure may be utilized to classify any discovered vulnerability into the STRIDE model. If there is no known countermeasure, STRIDE mitigation techniques as described above may be used to offer relevant risk management recommendations towards evading enumerated threat types to the exemplary cloud's assets. This approach may be implemented manually and/or may be implemented automatically as illustrated by example Algorithm 1:

Algorithm 1Threat Classification
Data: Cloud Configuration’s Entities
Result: Threat Types per each Entity — Vulnerability Pair
for Entity in Cloud Configuration do
| InvokeSecurity·Ontology·Knowledge·Base_{*} instance and pass
| the Entity name
| return Relevant found Vulnerabilities details
| for Each Found Vulnerability do
| | Perform A Similarity Test to all EoP Threat
| | Types descriptions call, with Entity’s Vulnerability
| | Description as a parameter
| | return Threat Types’s Similarity Scores
| | Perform A Classification Task, with Threat Types’s
| | Similarity Scores as a parameter
| | return Threat type that best suit the given Cloud’s
| | Entity — Vulnerability Pair
| end
end

For an exemplary cloud configuration, one approach to manage threat types that are found and generated via the threat classification approach is to rank them and provide an overall risk assessment indicator. This may be realized by using threat probability module 124 to estimate each cloud entity threat probability value and add them as weighted values toward generating an aggregated risk indicator via an embodiment of a risk estimator application. In certain embodiments, methods and systems utilize Bayesian threat probability determination. For example, threat probability module 124 may use a Bayesian network structure and variable calculation equations with extensions to accommodate various threat ranking needs. For instance, the equations may be grouped into a one or more variables including but not limited to: Threat Variable, Intermediate Vulnerability Variable, Vulnerability Variable, Attacker Variable, Control Combination Variable and Control Variable. Each variable may depend, in part, on one another. Certain embodiments use a Bayesian threat probability determination to give a risk manager a methodology to determine threat probability in a structured and comprehensible way. Further, a security ontology may be used to populate the proposed methodology. In this embodiment, threat probability may be populated using security OKB 110 comprising vulnerabilities OKB 101, symptoms OKB 102, defenses OKB 103, and attacks OKB 104, e.g., inferring the risk indicator for a cloud's assets. This may be automatically implemented, as illustrated by example Algorithm 2:

Algorithm 2 Threat Prolability Estimator
Data: Cloud Configuration's Entities and OKBs graphs
Result: A list of Threat Probabilities Values for all given
Cloud’s entitles
| for Entry in Cloud Configuration do
| InvokeSecurity·Ontology·Knowledge·Base_{*} instance and pass
| the Entity name and relevant OKB graph
| return Relevant found Vulnerabilities identifiers
| for Each Vulnerability identifiers do
| | Invoke controlVariable subroutine, with This Vulnerability
| | identifier and relevant OKB graph in a parameter
| | return A qualitative scale of this control for the
| | given vulnerability, its description and a binary
| | value of wether this control is active
| | Invoke ContolCombVariable subroutine, with control
| | Variable outputs and other variant's similar data
| | of This Vulnerability Identifier as parameters
| | return A qualitative scale and its quantitative value
| | Invoke AttackerVariable subroutine, with This Vulnerability
| | identifier and relevant OKB graph as parameters
| | return A qualitative scale and found Exploit Description
| | Invote vulnerabilityVariable subroutine, with
| | ControlCombVariable and AttackerVariable outputs as
| | parameters
| | return A quantitative scale
| | Append each Vulnerability identifier’s vulnerability-
| | Variable output into a list
| end
| Invoke [symbol] subroutine,
| with A list of vulnerabilityVariable outputs as parameters
| return A quantitive scale
| Invoke ThreatVariable subroutine, with
| intermedialeVulnerabilityVariable outputs and a list of
| aPrioriThreat Probabilities Values as parameters
| return A quantitative scale
| Append each Vulnerability identifier’s ThreatVariable
| output into a list
end [symbol]
indicates data missing or illegible when filed

Applications module 125 may include numerous applications to filter security analytics generated by the modules of system 100. In one embodiment, applications module 125 includes a Risk Estimator, Severity Ranking Engine, Exploitable Vulnerabilities Generator, and Suggested Configurations Generator. For an exemplary cloud configuration, each application may produce, e.g., an aggregated risk indicator, threat types severity ranks, exploitable vulnerabilities evaluations, and suggested new configurations to reduce perceived risk, respectively. The results of these applications may be implemented by implementation module 126 for vulnerability management. In certain embodiments, the applications of applications module 125 may be implemented automatically, as will be shown via exemplary algorithms.

An exemplary algorithm for a Risk Estimator application is illustrated by example Algorithm 3:

Algorithm 3 Risk Estimator
Data: A list of Threat Probabilities Values for all given
Cloud’s entities and their weights
Result: Aggregated Risk Indicator
for Input Data do
| Invoke an Aggregator subroutine and pass the Input
| Data as parameters
| return Aggregated Quantitative Scale
end

An exemplary algorithm for a Severity Ranking Engine application is illustrated by example Algorithm 4:

Algorithm 4 Seventy Ranking Engine
Data: Cloud Configuration’s Entities and OKBs graphs
Result: Threat Types Severity Rank
for Entity in Cloud Configuration do
| InvokeSecurity·Ontology·Knowledge·Base_{*} instance and
| pass the Entity stone and reletant OKB graph
| return Relevant found Vulnerabilities identifiers
| for Each Vulnerability identifier do
| | Invoke Threat Classification module, with This
| | Vulnerability identifier and relevant OKB graph as
| | a parameter
| | return Perceived Entity — Vulnerability’s Threat
| | Type
| | Invoke SeverityScore subroutine, with This Vulnerability
| | Identifier as parameters
| | return A quantitative severity score
| | Append the found severity scores per each vulnerability
| | into a list of threat type classes lists
| end
end
for All lists of threat type classes’s severity scores lists do
| Compute a new list of threat type classes’s average
| severity scores and return it
end

An exemplary algorithm for an Exploitable Vulnerabilities Generator application is illustrated by example Algorithm 5:

Algorithm 5 Exploitable Vulnerabilities Generator
Data: Cloud Configuration’s Entities and OKBs graphs
Result: Exploitable Vulnerabilities Evaluations
for Input Data do
| Invoke_{S}ecurity_{·}Ontology_{·}Knowledge_{·}Base_{*} instance and pass
| the Entity name and Vulnerability OKB graph
| return Counts of relevant found vulnerabilities, their
| identifiers and Active/Passive state binary value
| for Each vulnerability identifiers do
| | InvokeSecurity_{·}Ontology_{·}Knowledge_{·}Base_{*} instance and
| | pass the Entity name and Attack OKB graph
| | return Count of found Exploits
| | Append this Exploits Count into a list
| end
end
for All counted list’s values do
| Compute their sum with respect to their targeted
| vulnerabilities and return the Exploitable Vulnerabilities
| Evaluations
end

An exemplary algorithm for a Suggested Configurations Generator application is illustrated by example Algorithm 6:

Algorithm 6 Suggested Configurations Generator
Data: Cloud Configuration’s Entities and OKBs graphs
Result: Suggested Configurations to Reduce Perceived
Risk
for Input Data do
| Invoke Nemesis’s Threat Probability and Risk Estimator
| module and pass the Input Data
| return Aggregated Risk Indicator for this Cloud
| Configuration Profile and store this result for future
| comparison
| Invoke An Evaluator module and pass the Current
| Cloud Configuration Profile
| return All other alternative Cloud Configuration Profiles
| made of pre and post releases of the first Profile’s
| entities
| for Each generated Cloud’s Profile do
| | Compute its Aggregated Risk Indicator and store it
| end
| Perform A systematic ranking of each Cloud Configu-
| ration Profile and its Risk Indicator
| return The best optimal profile with a lower risk
| indicator and suggest it
|end

It is appreciated that in some cases the above example algorithms may be modified and/or steps be provided in different order. One skilled in the art would readily recognize that such modifications can be made while implementing the concepts shown herein.

All of the data acquired and processed by the various modules of system 100 may be implemented through implementation module 126. For instance, the level of risk management may be dependent on the level of risk associated with the vulnerabilities. There may be vulnerabilities that are low risk, and thus lower priority as determined by threat probability module 124. Less severe techniques may be implemented in that case. For high risk vulnerabilities, these may be attended to first, either automatically or user directed. Remediation of the vulnerabilities may include implementing new procedures, eliminating certain affected components, patching known vulnerabilities, and the like. Defenses OKB 103 may be invoked to implement a procedure that corresponds with the vulnerability at issue.

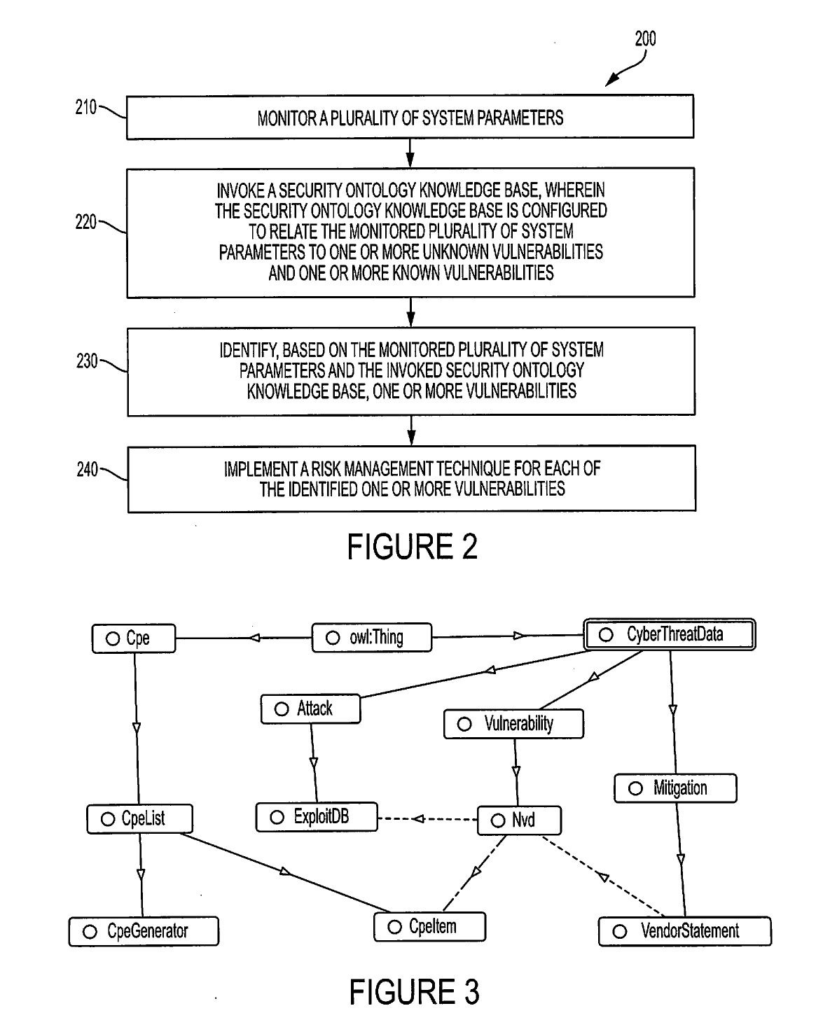

FIG. 2 illustrates a method 200 for performing adaptive vulnerability detection and mitigation in accordance with an embodiment of the present application. It is noted that method 200 may be implemented within one or more systems, such as system 100 described above. Method 200 may include monitoring a plurality of system parameters, e.g., I/O usage, bandwidth usage, faults, load balances, and the like at block 210. For example, monitoring system parameters may include identifying a type of cloud-based system to be monitored, e.g., personal, commercial, and/or government systems and depending on the type of identified system, system parameters to be monitored may be determined. The system parameters may be further determined using statistical techniques, e.g., principal component analysis and machine learning.

Method 200 may also include invoking a security ontology knowledge base at block 220. The security ontology knowledge base may be configured to relate the monitored plurality of system parameters (e.g., configurations such as installed hardware, OSs, applications, etc.) to one or more unknown vulnerabilities and one or more known vulnerabilities. The security ontology knowledge base at block 220 may further comprise a vulnerabilities ontology knowledge base, a symptoms ontology knowledge base, an attacks ontology knowledge base, and a defenses ontology knowledge base. These ontology knowledge bases may be populated and updated on demand and/or automatically from various sources. For instance, the vulnerabilities ontology knowledge base may be populated with known vulnerabilities from sources such as national databases and the like. Similarly, the vulnerabilities ontology knowledge base may be populated with unknown vulnerabilities from sources such as crowdsourced databases, unofficial databases, and other newly discovered vulnerabilities sources.

Method 200 may also include identifying, based on the monitored plurality of system parameters and the invoked security ontology knowledge base, one or more known vulnerabilities at block 230. Method 200 may also include identifying, based on the monitored plurality of system parameters and the invoked security ontology knowledge base, one or more unknown vulnerabilities at block 230. For example, known and unknown vulnerabilities may be identified by comparing the monitored plurality of system parameters with the vulnerabilities ontology knowledge base, e.g., known and unknown vulnerabilities, to determine if the monitored system parameters are susceptible to the vulnerabilities. In addition, the monitored system parameters may be compared to the symptoms ontology knowledge base to determine if the monitored system parameters differ from healthy state system behaviors, which may indicate an exploited vulnerability. Further, method 200 may include implementing a risk management technique for each of the identified one or more known vulnerabilities at block 240. Method 200 may also include implementing a risk management technique for each of the identified one or more unknown vulnerabilities at block 240. Risk management techniques may include isolating a component of the system from other components, implementing a defense from the defenses ontology knowledge base for an identified vulnerability, and/or prompting a system administrator to take action.

It is noted that the functional blocks and modules in FIGS. 1-7 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for adaptive vulnerability detection and management in a cloud-based system, the method comprising:
monitoring, by at least one processor, a plurality of system parameters of the cloud-based system;
invoking, by the at least one processor, a security ontology knowledge base, wherein the security ontology knowledge base is configured to relate the monitored plurality of system parameters to one or more unknown vulnerabilities and one or more known vulnerabilities;
identifying, by the at least one processor, based on the monitored plurality of system parameters and the invoked security ontology knowledge base, the one or more unknown vulnerabilities of the cloud-based system; and
implementing, by the at least one processor, a risk management technique for each of the identified one or more unknown vulnerabilities of the cloud-based system.

2. The method of claim 1 wherein the monitored plurality of system parameters include I/O usage, bandwidth usage, faults, and load balances.

3. The method of claim 1 wherein monitoring the plurality of system parameters further comprises:
identifying a type of the cloud-based system; and
determining, based on the identified type of the cloud-based system, the plurality of system parameters to monitor.

4. The method of claim 1 wherein the monitored plurality of system parameters are determined by at least one statistical technique, wherein the at least one statistical technique includes principal component analysis and machine learning techniques.

5. The method of claim 1 wherein the security ontology knowledge base comprises:
a vulnerabilities ontology knowledge base, wherein the vulnerabilities ontology knowledge base includes the one or more unknown vulnerabilities and the one or more known vulnerabilities;
a symptoms ontology knowledge base;
an attacks ontology knowledge base; and
a defenses ontology knowledge base.

6. The method of claim 5 wherein the vulnerabilities ontology knowledge base is configured to receive the one or more known vulnerabilities from one or more national database of vulnerabilities.

7. The method of claim 5 wherein the vulnerabilities ontology knowledge base is configured to receive the one or more unknown vulnerabilities from one or more unknown vulnerabilities sources.

8. The method of claim 7 wherein the one or more unknown vulnerabilities sources include crowdsourced vulnerability databases, forums, unofficial databases, and newly discovered attack resources.

9. The method of claim 5 wherein the symptoms ontology knowledge base is configured to receive one or more healthy state system parameters.

10. The method of claim 7 wherein the one or more unknown vulnerabilities sources include a comparison between the symptoms ontology knowledge base and the monitored plurality of system parameters, wherein the comparison results in a problem state indicative of a vulnerability.

11. A system comprising:
a memory; and
a processor coupled to the memory, the processor configured to execute the steps of:
monitoring a plurality of system parameters of a cloud-based system;
invoking a security ontology knowledge base, wherein the security ontology knowledge base is configured to relate the monitored plurality of system parameters to one or more unknown vulnerabilities and one or more known vulnerabilities;
identifying, by the at least one processor, based on the monitored plurality of system parameters and the invoked security ontology knowledge base, the one or more unknown vulnerabilities of the cloud-based system; and
implementing, by the at least one processor, a risk management technique for each of the identified one or more unknown vulnerabilities of the cloud-based system.

12. The system of claim 11 wherein the monitored plurality of system parameters include I/O usage, bandwidth usage, faults, and load balances.

13. The system of claim 11 wherein monitoring the plurality of system parameters further comprises:
identifying a type of the cloud-based system; and
determining, based on the identified type of the cloud-based system, the plurality of system parameters to monitor.

14. The system of claim 11 wherein the monitored plurality of system parameters are determined by at least one statistical technique, wherein the at least one statistical technique includes principal component analysis and machine learning techniques.

15. The system of claim 11 wherein the security ontology knowledge base comprises:
a vulnerabilities ontology knowledge base, wherein the vulnerabilities ontology knowledge base includes the one or more unknown vulnerabilities and the one or more known vulnerabilities;
a symptoms ontology knowledge base;
an attacks ontology knowledge base; and
a defenses ontology knowledge base.

16. The system of claim 15 wherein the vulnerabilities ontology knowledge base is configured to receive the one or more known vulnerabilities from one or more national database of vulnerabilities.

17. The system of claim 15 wherein the vulnerabilities ontology knowledge base is configured to receive the one or more unknown vulnerabilities from one or more unknown vulnerabilities sources.

18. The system of claim 17 wherein the one or more unknown vulnerabilities sources include crowdsourced vulnerability databases, forums, unofficial databases, and newly discovered attack resources.

19. The system of claim 15 wherein the symptoms ontology knowledge base is configured to receive one or more healthy state system parameters.

20. The system of claim 17 wherein the one or more unknown vulnerabilities sources include a comparison between the symptoms ontology knowledge base and the monitored plurality of system parameters, wherein the comparison results in a problem state indicative of a vulnerability.
